(19) United States
(12) Patent Application Publication
(10) Pub. No.: US 2009/0306929 A1
(43) Pub. Date: Dec. 10, 2009

(54) ULTRASONIC DIMENSIONING SYSTEM AND METHOD

(75) Inventors: Wenquan Li, Columbus, OH (US); Philip M. Metzler, Columbus, OH (US); Hugh G. Hindmon, Lewis Center, OH (US); John Scott Churan, Westerville, OH (US); Helen Winfrey, Reynoldsburg, OH (US)

Correspondence Address: STANDLEY LAW GROUP LLP, 6300 Riverside Drive, Dublin, OH, 43017, US

(73) Assignee: METTLER-TOLEDO, INC., Columbus, OH (US)

(21) Appl. No.: 12/133,181

(22) Filed: Jun. 4, 2008

(51) Int. Cl. G01B 15/00

(52) U.S. Cl. 702/155

(57) ABSTRACT

An ultrasonic dimensioning system and method by which objects can be quickly and accurately measured (dimensioned). The system includes at least a stable object support surface, a number of ultrasonic receivers, and an ultrasonic transmitter. The ultrasonic transmitter is preferably part of a pointer device that is properly positioned relative to an object to be measured, the proper position(s) depending on the shape of the object. Subsequent transmission of ultrasonic pulses (waves) from the pointer device are received by the ultrasonic receivers. The time intervals between transmission and reception of the ultrasonic pulses (waves) are used to determine the distance of the pointer from the receivers, which distances are subsequently used to calculate the dimensions/volume of the object.

### BACKGROUND OF THE INVENTIVE FIELD

The present invention is directed to the dimensional measurement of objects. More particularly, the present invention is directed to ultrasonic three-dimensional and/or volumetric measurement of objects of various shape and size.

As can be readily understood, the dimensional measurement (dimensioning) of objects is useful in a number of settings. Such measurement is of particular interest, for example, in the packaging and shipping industries. Billions of packages are shipped worldwide every year by any number of existing carriers. These carriers include, for example, government agencies such as the United States Postal Service® (USPS®) and private carriers such as United Parcel Service® (UPS®) and Federal Express® (FedEx®). According to its website, UPS® alone claims to have shipped approximately 3.9 billion packages and documents in 2006, on an average daily package and document volume of 15.6 million.

The shipping charges associated with such packages can be calculated in a number of ways. For example, a shipping charge may be based solely on the weight of a package, on the dimensions of a package, or on some combination of the weight and dimensions of a package. Whether or not the dimensions of a package play a role in determining its shipping cost, the dimensions of the package may also be used to determine if a package is within some size limit adopted by a carrier. For example, carriers may have length or girth restrictions.

It can thus be realized that it would be highly desirable to be able to quickly and accurately measure those packages whose dimensions are relevant to their shipping costs. That is, it is desirable to eliminate human or subjective errors associated with the use of measuring tools such as rulers, yardsticks, tape measures and given lengths of chain or string that are commonly employed to obtain various dimensional measurements of packages. Further, it is also desirable to obviate the need for a person to subsequently use such dimensional measurements to calculate package volume (when necessary), a task that can be quite complicated if a package of interest is not of standard cuboid shape.

In addition to the measurement of objects for purposes relating to their cost of shipping, object measurement may also be performed in other fields, such as in the warehousing industry and in the field of cargo transport. For example, in the warehousing industry, an exemplary object representative of a number of such objects to be stored may be measured to establish the amount of warehouse space that must be allocated therefor. In order to maximize available storage space, such measurements may also be used to determine the best location(s) to store the objects and/or the size/shape of groups (e.g., pallets) in which the objects should be stored.

Object measurement can also be useful with respect to space maximization of transit apparatus such as, for example, trucks, aircraft or other cargo containers or boat holds. That is, accurate measurement of objects that must be transported by such means allows for the development of loading plans that maximize the useable space of such transit apparatus. As such, each transit apparatus may be filled, or substantially filled, with objects to be transported. Because wasted space is minimized, fewer overall transit apparatus may be needed.

Object measurement may also be desirable in divergent fields, such as the sterilization field. For example, the sterilization of products (e.g., bandages) may occur while the products are still packaged. The proper sterilization time for such products may be based on the density of the package. Consequently, by weighing and also measuring the dimensions of such a package, its density can be easily calculated and the proper sterilization time subsequently determined.

As will become apparent from a reading of the following general summary and descriptions of various exemplary embodiments, a system and method of the present invention can be used to accomplish these functions and more.

### SUMMARY OF THE GENERAL INVENTIVE CONCEPT

The present invention is directed to an ultrasonic dimensioning system and method that can be used to quickly and accurately determine the dimensions and/or volume of an object such as, without limitation, a package, parcel or other item.

Certain exemplary embodiments of a system of the present invention may generally comprise a platter, platform or other object support surface onto which a package or other object to be measured is placed. In certain embodiments, one or more locating elements may be provided for locating through contact therewith at one or more side surfaces or axes of an object to be measured. In other embodiments of the present invention, locating elements may be absent, and/or or measurement techniques may be employed that do not require the use thereof. When the object support surface is a platter or similar element of a weighing device, the weight of the object to be measured may also be determined.

In other, portable, embodiments of the present invention, the object support surface may be absent. Rather, the objects to be measured may reside on a pallet or similar structure, or may sit on the ground or on a floor. For example, the objects to be measured may be too large and/or heavy to be transported to a remotely located measurement device. As such, the present invention contemplates that a portable ultrasonic dimensioning system may be transported to the objects to be measured, set up, and used to measure the objects of interest.

In one embodiment, a plurality of ultrasonic receivers is preferably mounted to a support structure or are otherwise positioned so as to receive signals from an electronic pointer. An electronic pointer for use in this embodiment preferably comprises an ultrasonic transmitter and may also include a transmitter activator and/or a positioning structure for facilitating proper positioning of the electronic pointer with respect to an object to be measured. When present, the configuration of the positioning structure may differ depending on the shape of the object(s) to be measured. In an alternate embodiment, a single ultrasonic receiver may be used in conjunction with a plurality of ultrasonic transmitters.

In operation, an object to be measured is placed on the object support surface and properly located, such as through the use of the above-referenced locating elements or otherwise. Alternatively, a portable system is located to the object(s) to be measured, as described above. The electronic pointer is then positioned to (i.e., placed in contact with, or placed very near) the proper point(s) on the object to be measured. For example, with respect to one measurement methodology of the present invention and with respect to a cuboid object, the electronic pointer may be contacted with a corner thereof that is triangularly opposite the corner of the object that is positioned by the support surface and the locating elements. As will be described in more detail below, other measurement methodologies may also be employed.

With the electronic pointer in proper position, the ultrasonic transmitter thereof is activated (whether manually or automatically) and ultrasonic pulses are sent to the receivers. The differences in the time required for the ultrasonic pulses to reach each ultrasonic receiver can be used to locate the point(s) of transmission and, thus, to calculate the dimensions/volume of the object by employing an adaptive dimensioning algorithm.

A calibrator may be provided to periodically measure the time required for an ultrasonic pulse to travel a known distance to a corresponding receiver. These measurements can be used by an electronic control circuit to compensate for the effects of temperature, humidity and/or other conditions on the speed of travel of the ultrasonic pulses emitted by the electronic pointer, therefore ensuring that the measurements produced by a system of the present invention are accurate. Alternatively, temperature, humidity and/or other ambient conditions can be measured and the measured values thereof can be used to appropriately calculate the speed of travel of the ultrasonic pulses produced by a system of the present invention.

As will be understood more clearly from a reading of the following description, object measurement may be achieved according to several measurement methodologies. For example, object measurement may be accomplished with one, two, three or five touches of the electronic pointer to the object to be measured. The particular methodology employed may depend on several factors, including the size and/or shape of the object(s) to be measured, and the ability to locate one or more side surfaces of the object to be measured against a locating element or other structure of known location.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view illustrating one exemplary embodiment of a system of the present invention for the ultrasonic dimensioning of objects;

FIGS. 2a and 2b depict one embodiment of an electronic pointer used in the system of FIG. 1;

FIG. 3 schematically illustrates one embodiment of a control circuit of the system of FIG. 1;

FIGS. 4a-4e make up a flow chart detailing the operative steps of an exemplary system of the present invention;

FIG. 5 illustrates the use of a two-touch methodology for measuring objects according to the present invention;

FIG. 6 illustrates the use of a three-touch methodology for measuring objects according to the present invention;

FIG. 7 illustrates the use of a five-touch methodology for measuring objects according to the present invention;

FIG. 8 graphically depicts the ultrasonic output pulse of an exemplary system of the present invention during operation thereof;

FIG. 9 depicts an auto-detection embodiment of the present invention associated with a one-touch measurement methodology;

FIG. 10 depicts an auto-detection embodiment of the present invention associated with a two-touch measurement methodology;

FIG. 11a depicts an alternative auto-detection embodiment of the present invention associated with a one-touch measurement methodology;

FIG. 11b depicts an alternative auto-detection embodiment of the present invention associated with a two-touch measurement methodology;

FIG. 12 depicts an auto-detection embodiment of the present invention associated with a three-touch measurement methodology;

FIGS. 13a-13b depict an auto-detection embodiment of the present invention associated with a five-touch measurement methodology;

FIGS. 14a-14b illustrate alternative embodiments of a system of the present invention designed to measure oversize objects using a one-touch measurement methodology; and

FIG. 15 illustrates an embodiment of a system of the present invention designed to measure oversize objects using a two-touch measurement methodology.

### DETAILED DESCRIPTION OF EXEMPLARY EMBODIMENT(S)

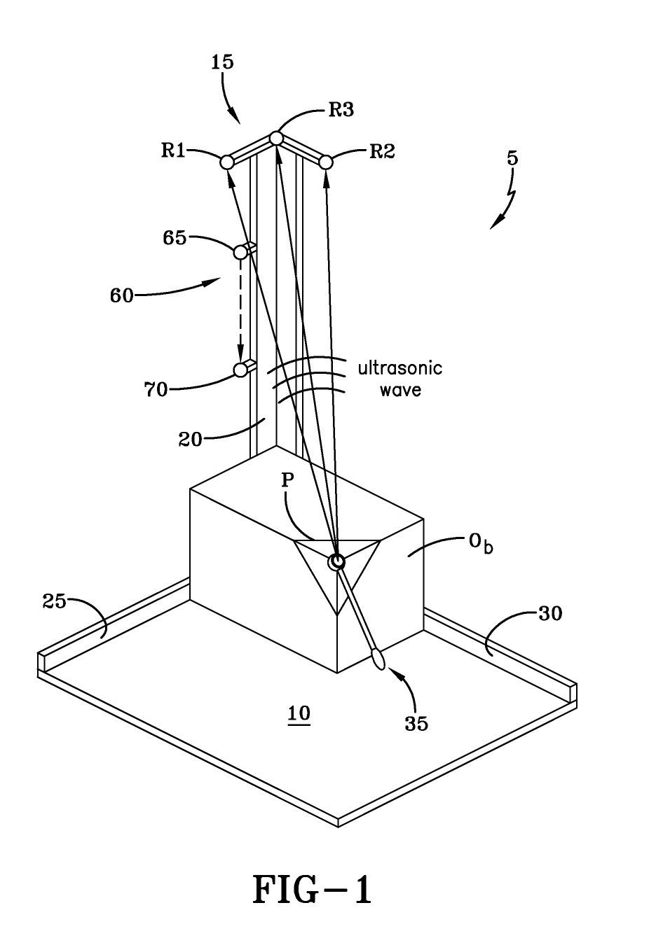

One exemplary embodiment of a dimensioning system 5 of the present invention is shown in FIG. 1. This particular embodiment of the dimensioning system 5 is designed to measure cuboid objects, such as the object O_{b} shown. It should be realized, however, that a system of the present invention can also be used to measure objects of other shapes.

In this embodiment, an object support surface 10 is preferably provided and located to receive and support an object to be measured during the measurement operation. The object support surface 10 may be of various size and shape, and may be constructed of virtually any material. In certain embodiments, the object to be measured is transported to the object support surface and resides thereon during the measurement process. Alternatively, portable versions of a system of the present invention may be set up at the location of an object(s) to be measured, in which case, the surface (e.g., floor, ground, etc.) upon which the object(s) rests can be used as a default object support surface.

An ultrasonic receiver assembly 15 is also provided. In this particular embodiment of the dimensioning system 5, the ultrasonic receiver assembly 15 is comprised of three ultrasonic receivers R₁, R₂ and R₃. Alternative embodiments of an ultrasonic receiver assembly 15 may employ more than three ultrasonic receivers. The ultrasonic receiver assembly 15 is preferably positioned so as to properly receive ultrasonic pulses from an ultrasonic transmitter (described in more detail below). For example, in this particular embodiment of the present invention, the ultrasonic receiver assembly 15 is located atop an extended receiver support structure 20. The ultrasonic receiver assembly 15 could also be located and mounted in other ways such as, for example, to a separate but acceptably near structure. In any event, the ultrasonic receiver assembly 15 is preferably mounted in a manner such that transmission of ultrasonic pulses or other signals thereto is not unacceptably obstructed.

In this particular embodiment, one or more locating elements may also be provided, such as on or adjacent to the object support surface. The locating element(s) function to locate through contact therewith one or more side surfaces (axes) of an object to be measured when certain measurement methodologies (described below) are employed. In this particular embodiment, the receiver support structure 20 may act as a partial locating element. More specifically, this particular receiver support structure 20 is of angular cross-section, such as may be associated with a length of structural C-channel or angle. As shown, the receiver support structure 20 has approximately a 90° cross-section, thereby providing a pair of perpendicular locating surfaces 25, 30 against which to abut and locate one or two side surfaces of the object to be measured O_{b}. As shown, the locating surfaces 25, 30 are also extended along the periphery of the object support surface 10 in this embodiment. It should be realized, however, that when such extended locating surfaces are present, neither locating surface is required to be attached or otherwise connected to the object support surface 10. Rather, such extended locating surfaces can be attached to another nearby object or structure. For example, depending on the location of the system when in use, such locating surfaces 25, 30 may be formed by preexisting structure, such as the vertical walls of a shop/store counter that acts as the object support surface.

Other methods of properly locating an object to be measured O_{b} can also be employed, such as via one or more locating pins or other elements that are affixed to the surface or edges of the object support surface 10 or to another nearby object or structure. Other acceptable locating structures would be apparent to one skilled in the art, and nothing herein should be interpreted as limiting a system of the present invention to any particular locating element(s). As an alternative to a locating element/structure, the object support surface 10 may be provided with one or more markings that indicate to a user of the system where an object to be measured O_{b} is to be located thereon for measurement. Various markings may be provided, such as to indicate the proper or preferred position of objects of different shape, etc. In yet other embodiments, no locating elements or positioning markings may be present.

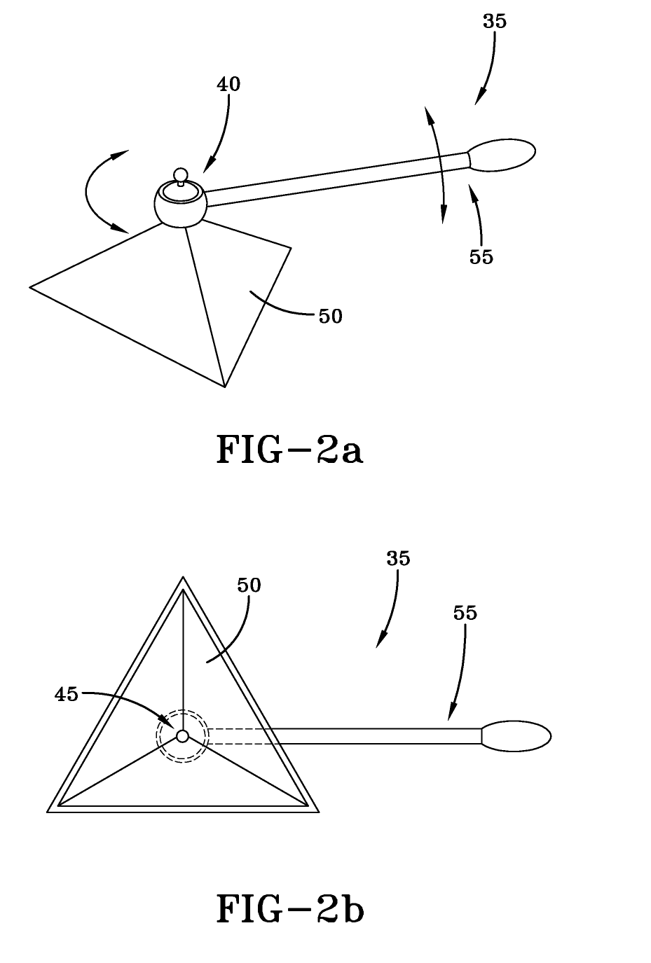

As shown in greater detail in FIGS. 2a-2b, a system of the present invention also preferably includes an electronic pointer 35. The electronic pointer 35 preferably comprises an ultrasonic transmitter (indicated generally by 40) and may include a transmitter activator 45. When present, the transmitter activator may include a trigger or other activator to be operated by a user of the system, or may include a pushbutton or similar element that is activated by contact of the electronic pointer with an object to be measured (as described in more detail below). Alternatively, an electronic pointer of the present invention may be devoid of a transmitter activator. Instead, the transmitter of the electronic pointer may automatically and continually transmit ultrasonic pulses at some predetermined interval—thus, eliminating the need for case-by-case activation.

The electronic pointer 35 may also include a positioning structure 50 that aids in properly positioning the indicator to a point(s) on the object to be measured O_{b}. In this particular embodiment of the electronic pointer 35, the positioning structure 50 is a substantially hollow triangular cone designed to fit over a corner of the cuboid-shaped object to be measured O_{b}. Obviously, however, the configuration of any positioning structure 50 may vary depending on the particular shape of the object(s) to be measured.

In this particular embodiment, the transmitter activator 45 is present and comprises a pushbutton that is depressed upon proper positioning of the electronic pointer 35 to the object to be measured O_{b}. More specifically, the pushbutton is depressed and activated by contact with a corner or other surface of the object to be measured O_{b} when the electronic pointer 35 is properly positioned thereto.

Alternate electronic pointer embodiments may employ transmitter activators of other design. Similarly, alternate embodiments may have transmitter activators arranged at other locations thereon or therein. For example, a pushbutton or other switch may be located on a handle or other graspable structure of an electronic pointer such that activation of the associated ultrasonic transmitter may be accomplished by a user of the system. In such a case, the operator places the electronic pointer in contact with, or in close proximity to, a point on an object to be measured, and subsequently activates the ultrasonic transmitter to initiate the measurement operation.

The electronic pointer 35 is preferably also adapted to allow for easy manipulation and positioning or placement by a user thereof. For example, as shown herein, the electronic pointer 35 may be provided with a handle 55 for this purpose. One skilled in the art would certainly realize that an electronic pointer of the present invention could be provided with a myriad of different structures for this purpose and, further, nothing herein is to be interpreted as limiting an electronic pointer to the illustrative configuration shown and/or described.

With respect to the use of an electronic pointer of the present invention, it is to be understood that the term “touch” (and other forms of the “touch” lexeme), as used herein, is considered to include physically contacting an electronic pointer with an object to be dimensioned, as well as positioning an electronic pointer near enough a point of interest on an object to be dimensioned so as to permit the transmission of sufficiently accurate coordinates associated with said point, without actually contacting the object. As such, nothing herein is to be interpreted as necessarily requiring physical contact between an electronic pointer of the present invention and an object to be measured.

Any embodiment of a dimensioning system of the present invention may include a calibrator, such as the calibrator 60 shown in FIG. 1, that is used to account for potential environmental effects on the measurements produced by the dimensioning system. The calibrator 60 may include a real-time reference ultrasonic transmitter 65 associated with a corresponding reference ultrasonic receiver 70. In the particular exemplary embodiment shown, the reference ultrasonic transmitter 65 and reference ultrasonic receiver 70 are arranged at a fixed and known distance from one another. For example, the reference ultrasonic transmitter 65 and reference ultrasonic receiver 70 may be affixed to the receiver support structure 20, to another component of the dimensioning system 5, or to a separate structure that is preferably subjected to the same environmental conditions.

The calibrator 60 periodically measures the time required for an ultrasonic pulse to travel from the reference ultrasonic transmitter 65 to the reference ultrasonic receiver 70. These time measurements are indicative of the real-time speed at which the ultrasonic pulses are traveling in a given environment. These time/speed measurements can be used by an electronic control circuit to compensate the measurements produced by a system of the present invention for the effects of temperature, humidity and/or other conditions if necessary.

In an alternative embodiment of the present invention, a calibrator may be comprised of the same ultrasonic receiver assembly and electronic pointer that are used to measure objects of interest. For example, the ultrasonic receiver 15 and electronic pointer 35 may function as a calibrator as long as the distance therebetween is known. To this end, a cradle or other holder of fixed location may be provided for holding the electronic pointer when not in use or when calibration is desired. With the distance between the holder and the ultrasonic receiver known, calibration can then be accomplished as described above. Such a holder may be affixed to a receiver support structure or placed at virtually any other location where the transmission of ultrasonic pulses between the electronic pointer and ultrasonic receiver is not unacceptably obstructed.

In yet another embodiment of the present invention, environmental conditions (e.g., temperature, humidity, etc.) may be directly measured and those measurements subsequently used to adjust for their effect on the speed of travel of the ultrasonic pulses (i.e., the speed of sound). More specifically, because the effects of temperature, pressure and other environmental factors on the speed of sound in air are known, measurements of each can be used to determine the actual speed of the ultrasonic pulses at any given time. For example, based on a measured environmental condition, or combination of conditions, an adjusted speed of sound may be retrieved from a look-up table or another source. As such, the true speed of travel of the ultrasonic pulses can be used in the calculation of the size of an object of interest.

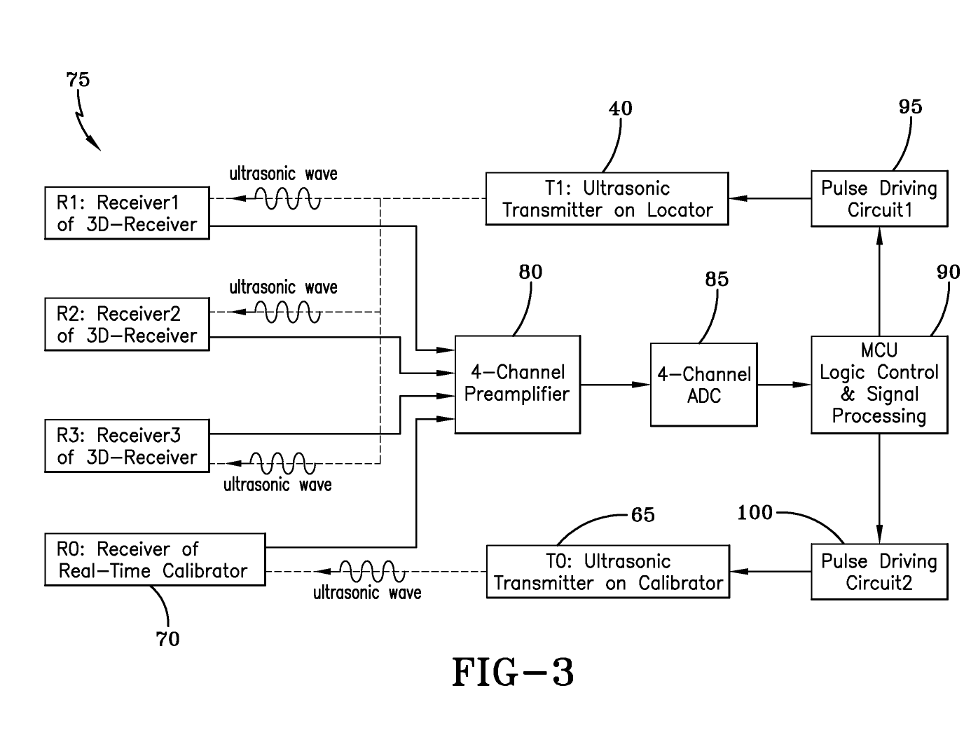

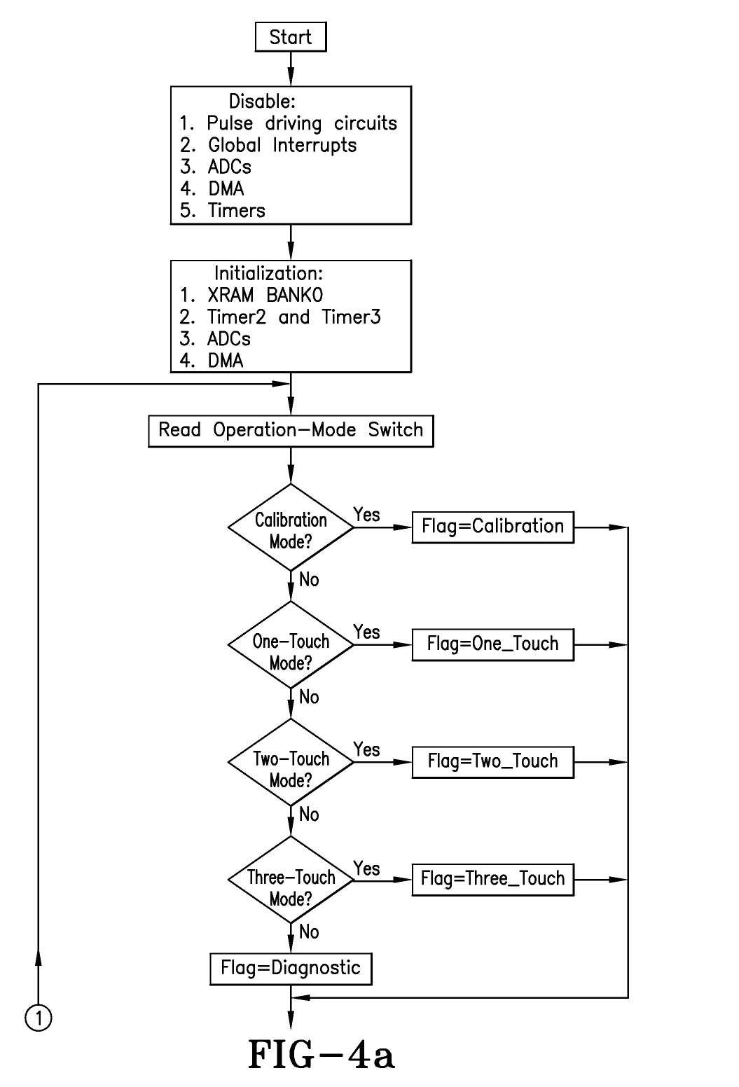

Operational coordination of the dimensioning system 5 is accomplished by an electronic control circuit 75, an exemplary embodiment of which is schematically depicted in FIG. 3. The embodiment of FIG. 3 is shown for illustrative purposes only, and one skilled in the art would realize that many equivalent circuits might be constructed. As such, a dimensioning system of the present invention is not to be limited to the use of the specific control circuit 75 components or topology illustrated in FIG. 3 and described herein.

As shown in FIG. 3, this particular electronic control circuit 75 includes a four channel amplifier 80 connected to ultrasonic receivers R₁, R₂ and R₃ of the ultrasonic receiver assembly 15. Preferably, but not necessarily, the reference ultrasonic receiver 70 is also connected to the amplifier 80, although the reference ultrasonic receiver could also be associated with a separate amplifier. In this embodiment, signals from each of the ultrasonic receivers R₁, R₂ and R₃ and the reference ultrasonic receiver 70 are passed from the amplifier 80 to a multi-channel analog-to-digital (A/D) converter 85 for conversion to digital form.

The A/D converter 85 may be any of various known or hereinafter developed devices/circuits for accomplishing analog to digital signal conversion. For example, in certain exemplary embodiments of the present invention, it has been found that a 16-bit SAR A/D converter having a maximum sampling rate of 1 mega-samples/second, a full input-voltage range of between 0-3 V, and an independent, temperature stable 1.2 V band-gap voltage reference, works especially well. Of course, one skilled in the art would realize that A/D converters with different specifications could also be used.

The A/D converter 85 is in turn connected to a microcontroller (MCU) 90, that provides for necessary logic control and signal processing. The MCU 90 is connected to two pulse driving circuits 95, 100. The first pulse driving circuit 95 drives the ultrasonic transmitter 40 of the electronic pointer 35, while the second pulse driving circuit 100 drives the reference ultrasonic transmitter 65.

For purposes of simplicity in the following exemplary operational descriptions of the present invention, the surface of an object to be measured that resides on the object support surface will be referred to as the “bottom” surface, whether or not that surface is actually considered to be the bottom surface of the object. Similarly, the surface of the object opposite to the “bottom” surface will be referred to as the “top” surface, whether or not that surface is actually considered to be the top surface of the object. References to “bottom corners” or “top corners” are then simply references to corners of the object lying in the same plane as the bottom surface or top surface, respectively.

### One-Touch Methodology

According to one version of the present invention, a one-touch measurement methodology may be employed to determine the dimensions/volume of an object to be measured O_{b}. In this case, and as represented in FIG. 1, an object to be measured O_{b} is first placed on the object support surface 10 and two side surfaces thereof are located against the locating surfaces 25, 30 so as to locate a bottom corner of the object. Subsequently thereto, a user of the system positions the electronic pointer 35 to the proper point on the object to be measured O_{b}. In this case, the proper point P is a top corner of the object to be measured O_{b} that is diagonally opposed to the corner of the object to be measured that resides on the object support surface 10 and is located against the corner formed by the receiver support structure 20. As shown in FIG. 1, this is the top right corner of the front face of the object to be measured O_{b}.

Once the electronic pointer 35 is properly positioned with respect to the object to be measured O_{b}, the transmitter 40 sends an enable signal to the MCU 90, as described in more detail below. Transmitter activation may occur in any of the ways described above.

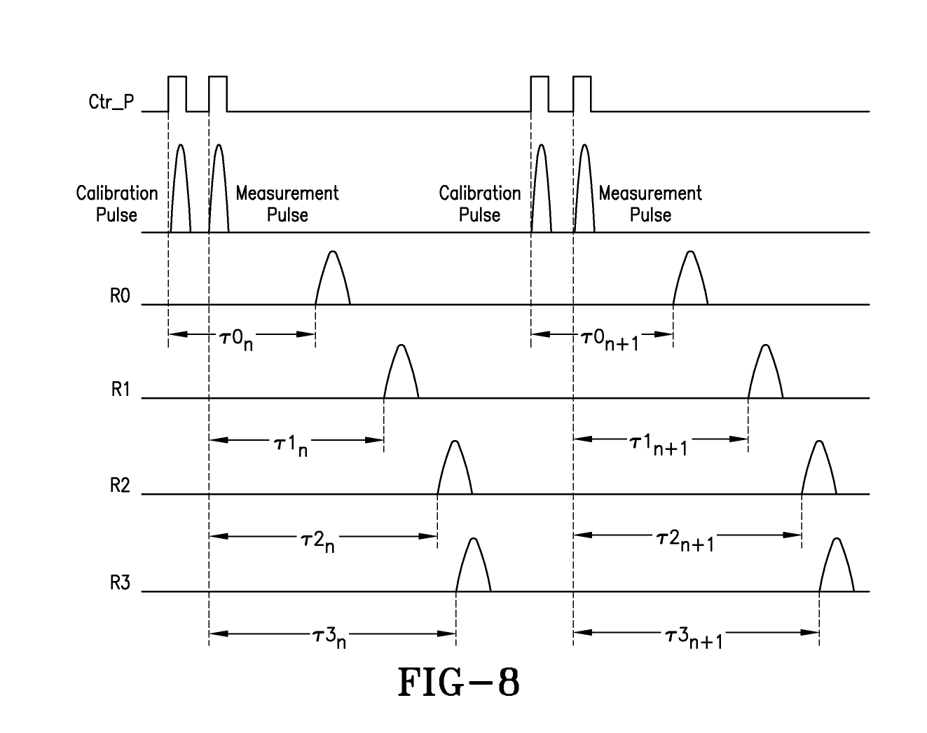

As can be best observed in FIG. 8, the time intervals τ1_{N}, τ2_{N} and τ3_{N} are then used in conjunction with the following formulas, which together comprise an exemplary multilateration algorithm that can be used to calculate the dimensions/volume of a cuboid object to be measured O_{b}:

$$\begin{matrix}τ0 = \frac{1}{N} {\sum }_{n = 1}^{N} {τ0}_{n} , v = \frac{L 0}{τ0} \\ τ1 = \frac{1}{N} {\sum }_{n = 1}^{N} {τ1}_{n} , L 1 = v \cdot τ1 \\ τ2 = \frac{1}{N} {\sum }_{n = 1}^{N} {τ2}_{n} , L 2 = v \cdot τ2 \\ τ3 = \frac{1}{N} {\sum }_{n = 1}^{N} {τ3}_{n} , L 3 = v \cdot τ3 \\ y = \frac{L {3}^{2} + {Y}^{2} - L {2}^{2}}{2 Y} \\ u = \frac{{X}^{2} + L {3}^{2} - L {1}^{2}}{2 X} \\ z = Z - \sqrt{L {3}^{2} - {y}^{2} - {u}^{2}} \\ x = \sqrt{L {3}^{2} - {y}^{2} - {( Z - z )}^{2}} \\ volume = xyz\end{matrix}$$

where τ0_{N} (n=1, 2, 3 . . . N) is the time interval between transmission of a calibration pulse by the reference ultrasonic transmitter 65 and its reception by the reference ultrasonic receiver 70; τ1_{N} (n=1, 2, 3 . . . N) is the time interval between transmission by the ultrasonic transmitter 40 of a measurement pulse and its receipt by the first ultrasonic receiver R₁; τ2_{N} (n=1, 2, 3 . . . N) is the time interval between transmission by the ultrasonic transmitter 40 of a measurement pulse and its receipt by the second ultrasonic receiver R₂; τ3_{N} (n=1, 2, 3 . . . N) is the time interval between transmission by the ultrasonic transmitter 40 of a measurement pulse and its receipt by the third ultrasonic receiver R₃; L1 is the distance between the ultrasonic transmitter and the first ultrasonic receiver; L2 is the distance between the ultrasonic transmitter and the second ultrasonic receiver; L3 is the distance between the ultrasonic transmitter and the third ultrasonic receiver; (X, 0, Z) represents the coordinates of the ultrasonic receiver R₁; (0, Y, Z) represents the coordinates of the ultrasonic receiver R₂; (0, 0, Z) represents the coordinates of the ultrasonic receiver R₃; x is the measured x-dimension of the object; y is the measured y-dimension of the object; and z is the measured z-dimension of the object.

### Two-Touch Methodology

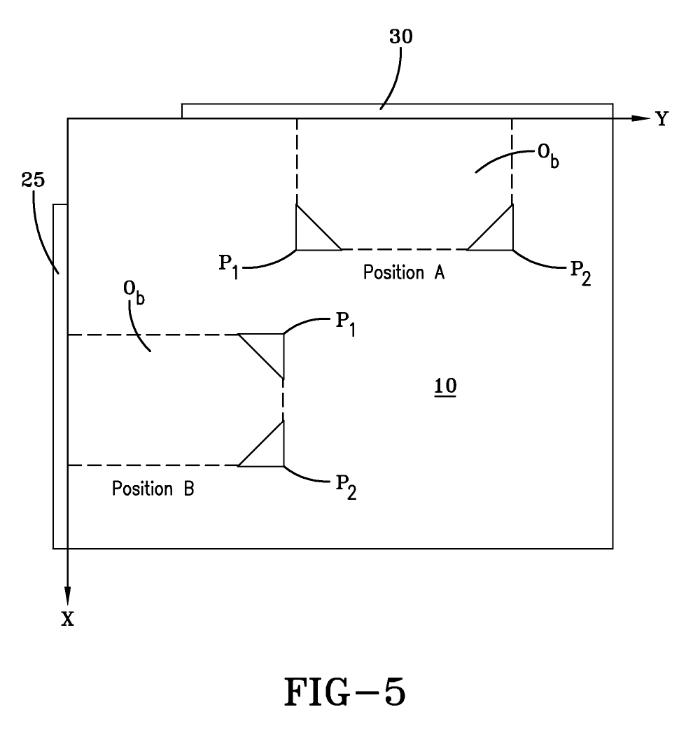

As can be best observed in FIG. 5, a two-touch measurement methodology may also be employed to determine the dimensions/volume of an object to be measured O_{b}. In this case, the object to be measured O_{b} is first placed on the object support surface 10 and at least one side surface thereof is located against some portion of a locating element, such as one of the locating surfaces 25, 30 if such are both present (e.g., either in position A or position B). Subsequently thereto, a user of the system locates the electronic pointer 35 to the proper points on the object to be measured O_{b}. In this case, the proper points P₁, P₂ are the top corners of the object to be measured O_{b} that are diagonally opposed to the bottom corners of the object to be measured that reside against the selected locating surface (i.e., surface 25 or 30). As shown in FIG. 5, these are the top corners of the front face of the object to be measured O_{b}—the “front face” being the face opposite the face placed against a locating surface.

After each touch is made at the identified points P₁, P₂, electronic pulses are transmitted and received in any of the ways described herein. The coordinates of the points P₁, P₂ may be subsequently determined utilizing the process and formulas associated with the one-touch method previously described.

The following formulas, in conjunction with the formulas listed above, are parts of an exemplary multilateration algorithm that can be used to determine the dimensions/volume of the object to be measured O_{b}:

$$Δ X = \vert x 1 - x 2 \vert , Δ Y = \vert y 1 - y 2 \vert , Δ Z = \frac{z 1 + z 2}{2}$$

where (x1, y1, z1) represents the coordinates of the first point P₁; (x2, y2, z2) represents the coordinates of the second point P₂; and ΔX, ΔY and ΔZ represent the length of the object to be measured O_{b} along its X, Y and Z axes, respectively.

### Three-Touch Methodology

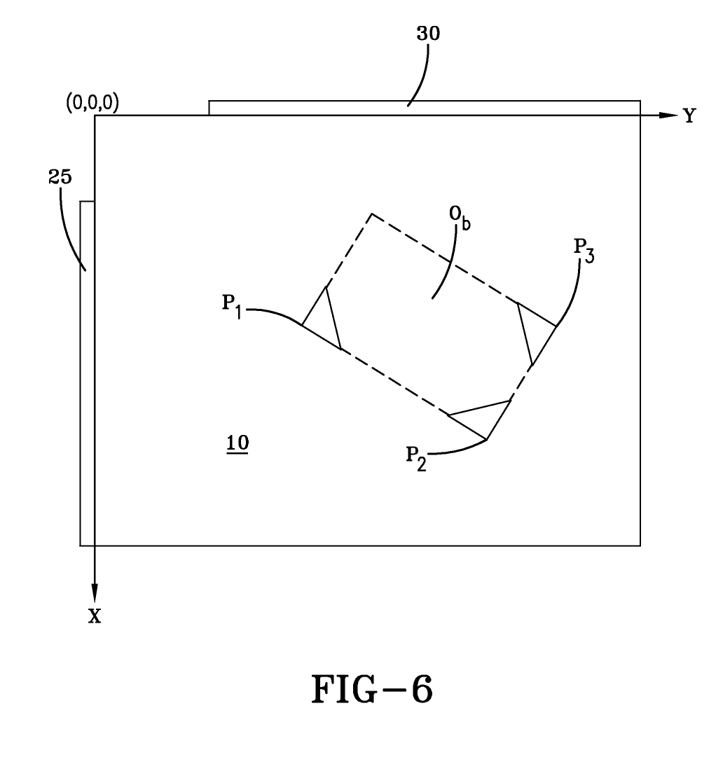

Referring now to FIG. 6, it can be seen that a three-touch measurement methodology may be employed to determine the dimensions/volume of an object to be measured O_{b} according to another version of the present invention. In this case, the object to be measured O_{b} is first placed with its bottom surface on the object support surface 10. Unlike the previously described one-touch and two-touch object measurement methodologies, none of the side surfaces of the object to be measured O_{b} need be located against a locating element. Thus, when employing the three-touch measurement methodology, such locating elements may be absent or may simply be unused.

Subsequently to placing the object to be measured O_{b} on the object support surface 10, a user of the system positions the electronic pointer 35 to the proper points on the object to be measured. As shown in FIG. 6, the proper points P₁, P₂, P₃ in this case are any three of the four top corners of the object to be measured O_{b}.

After each touch is made at the identified points P₁, P₂, P₃, electronic pulses are transmitted and received in any of the ways described herein. The coordinates of the points P₁, P₂, P₃ may be subsequently determined utilizing the process and formulas associated with the one-touch and two-touch methods previously described.

In conjunction with the foregoing formulas, the dimensions of the object to be measured O_{b} can be determined using the following formulas, which are parts of an exemplary multilateration and dimensioning algorithm:

$$\begin{matrix}Δ X = \sqrt{{( x 1 - x 2 )}^{2} + {( y 1 - y 2 )}^{2}} \\ Δ Y = \sqrt{{( x 2 - x 3 )}^{2} + {( y 2 - y 3 )}^{2}} \\ Δ Z = \frac{z 1 + z 2 + z 3}{3}\end{matrix}$$

where (x1, y1, z1) represents the coordinates of the first point P₁; (x2, y2, z2) represents the coordinates of the second point P₂; (x3, y3, z3) represents the coordinates of the third point P₃; and ΔX, ΔY and ΔZ represents the length of the object to be measured O_{b} along its X, Y and Z axis, respectively.

### Five-Touch Methodology

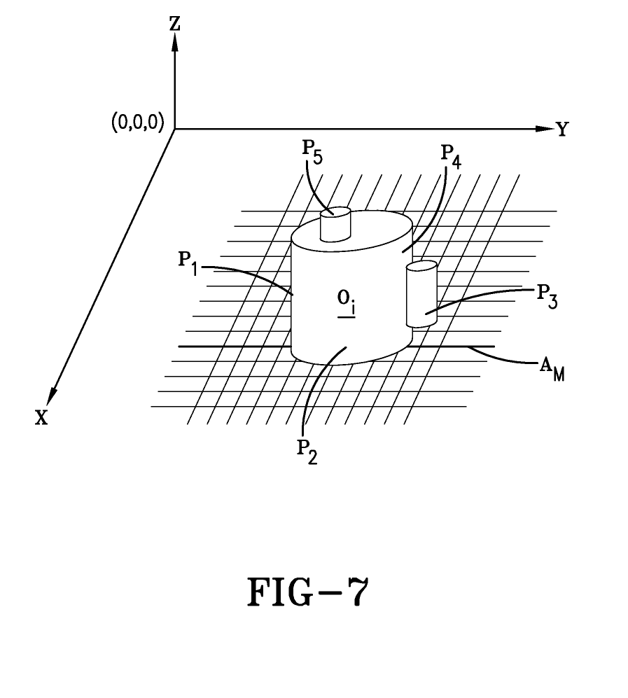

According to yet another version of the present invention, which is illustrated in FIG. 7, a five-touch measurement methodology may also be practiced. This measurement methodology is particularly applicable to measuring irregular (non-cuboidal) objects, although its use is not to be considered in any way limited thereto. For example, the five-touch methodology may be especially well-suited to determining the dimensions of a cuboid capable of enclosing such an irregularly-shaped object. This would be useful in determining the size of a shipping carton used to package an irregularly-shaped object such as, for example, a tennis racket, a golf club or a lamp.

Alternatively, this five-touch methodology may be useful for determining the cuboid shape (volume) that such an object would occupy if it were to be loaded onto/into a transport means, such as a truck, railway car, airplane, or cargo (ship) container. For example, such an object(s) may reside on a pallet where it overhangs one or more sides. The size and/or volume of the subsequently determined cuboid could then be used for various purposes such as, for example, by a parcel carrier, trucking company, etc., to calculate fees corresponding to the correct shipping charge for the object.

In this mode of operation, the orientation of a reference X-Y-Z coordinate system is initially determined. The orientation of the X-Y axis relative to the object is generally subjective. The X-Y axis typically, but not necessarily, coincides with the longest or major axis A_{M} of the object of interest. With an object like a tennis racket, for example, the major axis may be defined as the axis that runs from the bottom of the handle, through the shaft, to the top of the racket. In the case of a pallet with overhanging cargo, the major axis might be set to coincide with either of the sides of the pallet. Typically, the Z axis is assumed to be oriented vertically, perpendicular to the object support surface (e.g., platter, counter, floor, etc.). Obviously, a multitude of reference axis system orientations may be possible with almost any object of interest, and nothing herein is to be determined as limiting the designation of the major axis of an object of interest to any exemplary axis shown and/or otherwise described herein.

As illustrated in FIG. 7, once the major axis A_{M} is selected, an electronic pointer (e.g., the electronic pointer 35 described above) is used to touch the object of interest Oᵢ at five different locations. As can be understood from the above descriptions of other exemplary embodiments, touching of the object of interest Oᵢ results in the transmission of the coordinates corresponding to the location of the touches. Two of the points touched on the object of interest Oᵢ will lie along the major axis A_{M}, at the farthest extents thereof. Two other touches will be made on opposite sides of the object of interest Oᵢ, at points on the object farthest away from the major axis A_{M}. A fifth touch will be made at the highest point on the object of interest Oᵢ.

As shown in the particular example of FIG. 7, the major axis A_{M} has been selected to coincide with what has been labeled the Y axis. An electronic pointer is first positioned to a first side of the object, such as at point P₁. The electronic pointer is then subsequently moved around the object of interest Oᵢ in a counter-clockwise direction, making three more measurements (touches), such as at the points P₂, P₃, P₄ shown. A fifth measurement (touch) is then performed at the highest point P₅ on the object of interest Oᵢ.

The volume/dimensions of a cuboid that would enclose the object of interest Oᵢ can then be determined using the following formulas, which are part of an exemplary multilateration and dimensioning algorithm:

$$\begin{matrix}Δ X = \sqrt{{( x 1 - x 3 )}^{2} + {( y 1 - y 3 )}^{2}} \\ Δ Y = \frac{\vert ( y 2 - y 1 ) - ( x 2 - x 1 ) β \vert + \vert ( y 4 - y 1 ) - ( x 4 - x 1 ) β \vert}{1 + {β}^{2}} , \\ where β = \vert \frac{y 3 - y 1}{x 3 - x 1} \vert \\ Δ Z = z 5\end{matrix}$$

where (x1, y1, z1) represents the coordinates of the first point P₁; (x2, y2, z2) represents the coordinates of the second point P₂; (x3, y3, z3) represents the coordinates of the third point P₃; (x4, y4, z4) represents the coordinates of the fourth point P₄; (x5, y5, z5) represents the coordinates of the fifth point P₅; and ΔX, ΔY and ΔZ represent the lengths along an X, Y and Z axis, respectively, of a cuboid that would enclose the object to be measured O_{b}.

Ultrasonic pulse transmission and pulse receipt may be performed in several different ways with respect to any system and measurement methodology of the present invention. With reference to FIGS. 3, 4a-4b and FIG. 8, it can be observed that upon receipt of an enable signal, the MCU 90 preferably sends out a number of control pulses Ctr_P to the pulse driving circuits 95, 100 of the control circuit 75. In this case, eight control pulses Ctr_P are sent, but the number of control pulses is variable. The pulse driving circuits 95, 100 convert the control pulses Ctr_P into high-voltage pulses that drive both the ultrasonic transmitter 40 of the electronic pointer 35 and the reference ultrasonic transmitter 65, respectively.

The transmitter 40 of the electronic pointer 35 subsequently transmits a series of ultrasonic pulses (waves) that are received by the ultrasonic receivers R₁, R₂ and R₃ of the ultrasonic receiver assembly 15. Similarly, the reference ultrasonic transmitter 65 transmits a series of ultrasonic pulses (waves) that are received by the reference ultrasonic receiver 70.

The first pulse generally acts as a calibration pulse, as is described in more detail below. The second pulse generally acts as a measurement pulse, as is also described in more detail below. The time interval between pulses can vary but, typically, the calibration and measurement pulses are not sent simultaneously. As illustrated in FIG. 8, calibration and measurement pulses can optionally be transmitted in pairs.

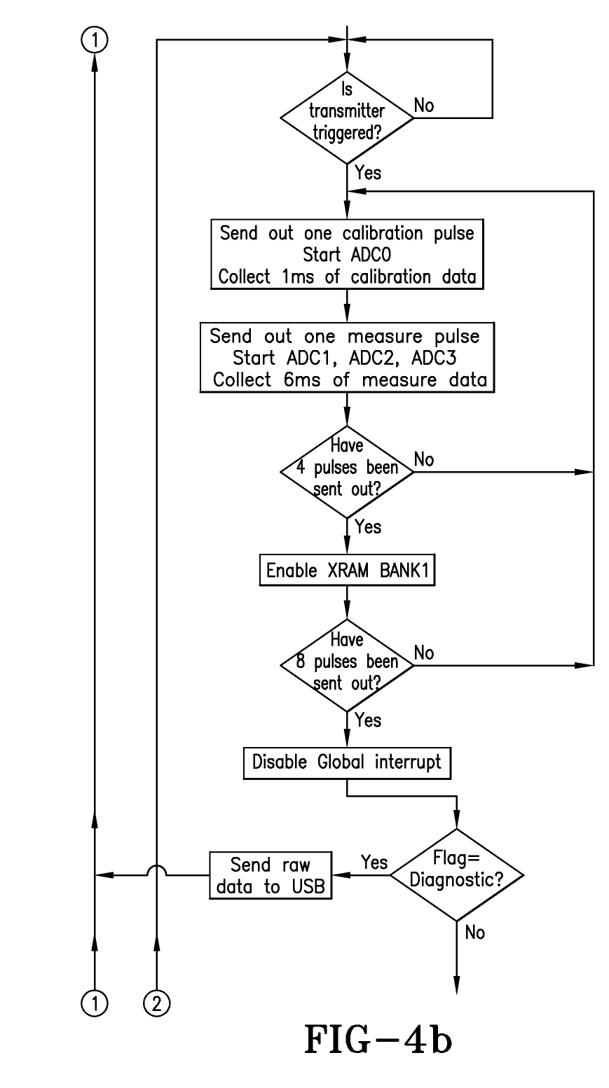

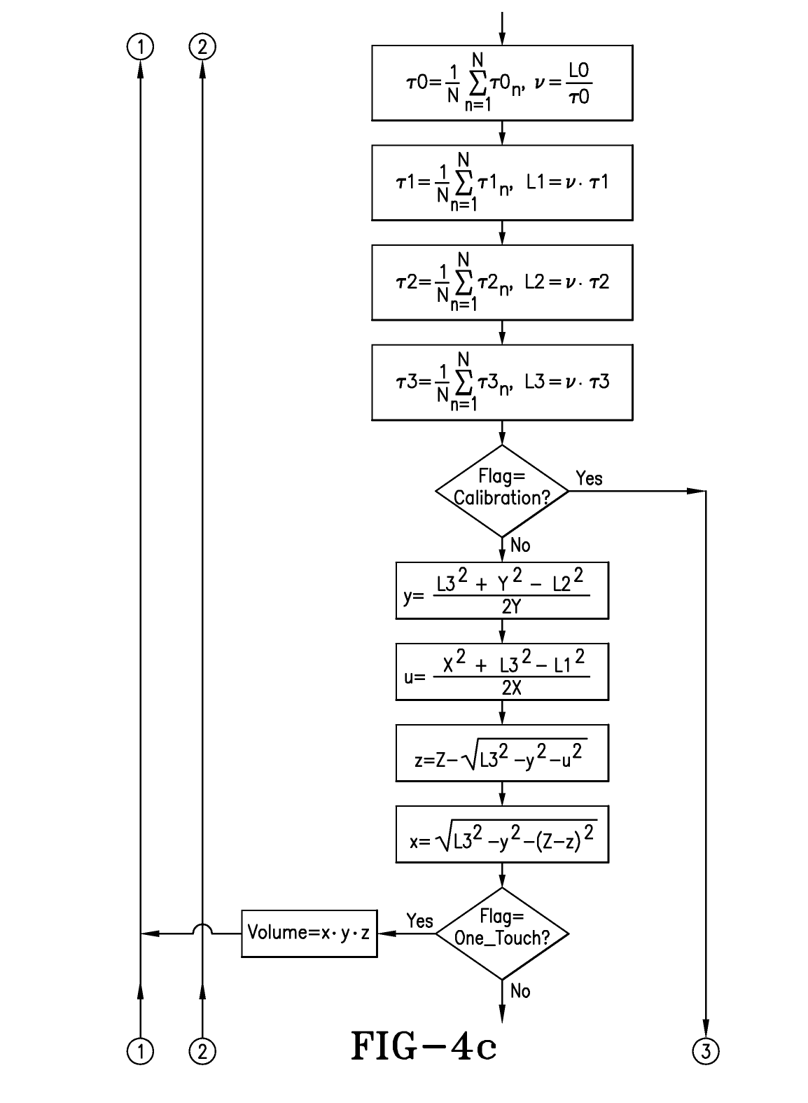

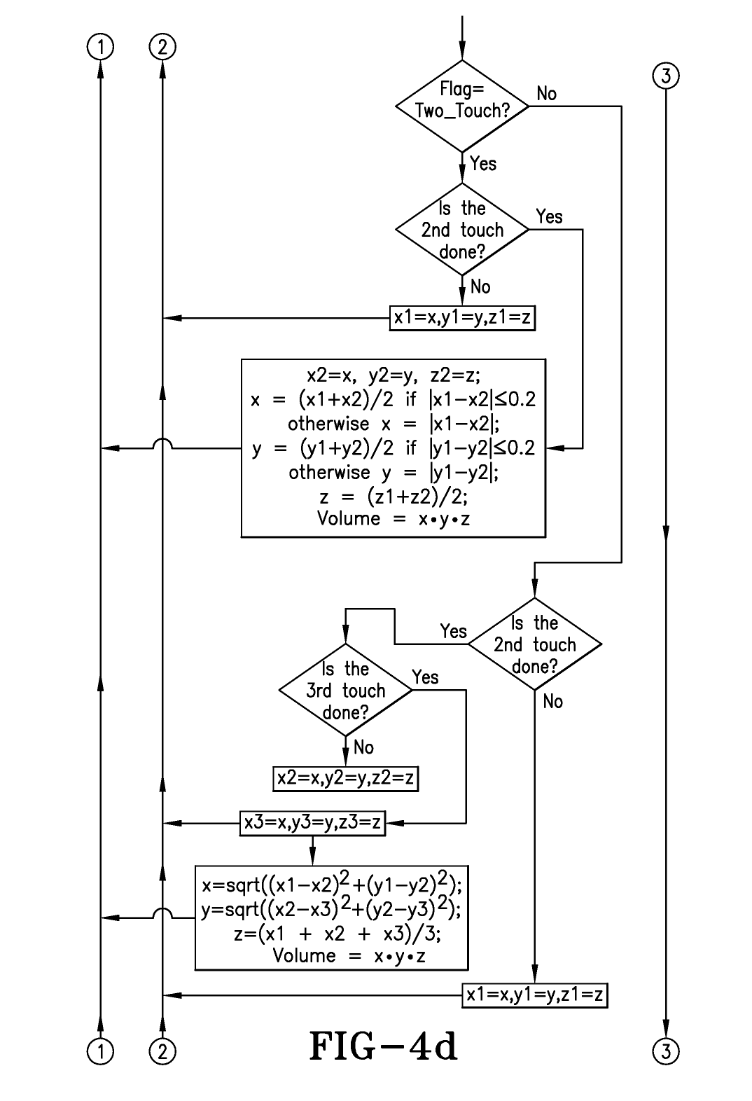

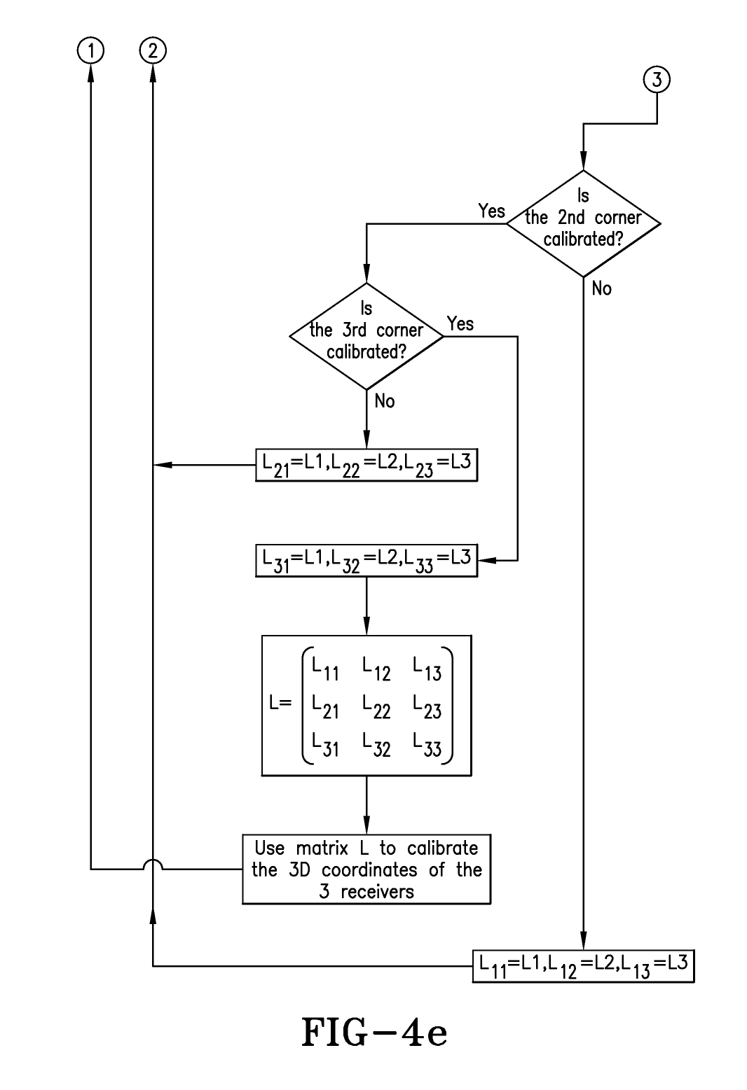

As can be understood by reference to FIGS. 4a-4e and 8, the time between transmission of the calibration and measurement pulses and reception by their corresponding receivers is used to determine the dimensions of the object to be measured O_{b}. More specifically, in this particular example, the time interval τ0_{N} (n=1, 2, 3 . . . N) is the time interval between transmission of a calibration pulse by the reference ultrasonic transmitter 65 and its reception by the reference ultrasonic receiver 70. This time interval is used to determine the real-time speed of the ultrasonic pulses (waves) and can be used to compensate the measurement readings. Similarly, τ1_{N} (n=1, 2, 3 . . . N) is the time interval between transmission by the ultrasonic transmitter 40 of a measurement pulse and its receipt by the first ultrasonic receiver R₁; τ2_{N} (n=1, 2, 3 . . . N) is the time interval between transmission by the ultrasonic transmitter 40 of a measurement pulse and its receipt by the second ultrasonic receiver R₂; and τ3_{N} (n=1, 2, 3 . . . N) is the time interval between transmission by the ultrasonic transmitter 40 of a measurement pulse and its receipt by the third ultrasonic receiver R₃. Once the time intervals τ1, τ2 and τ3 are obtained, the distances between the ultrasonic transmitter and the three ultrasonic receivers can be calculated by multiplying the time intervals with the real-time speed of the calibration ultrasonic wave.

A system of the present invention may employ an auto-detect feature, regardless of the particular measurement methodology used. For example, sensors may be provided to detect the presence of an object to be measured. These, or other sensors, may also determine the measurement methodology that will be used.

Sensors S may be integrated into locating elements, such as the locating surfaces A, B shown in FIG. 9. Alternatively, sensors may be located in close proximity to the reference planes X, Y formed by such locating elements. For example, a series of micro switches may be installed into the locating elements, such as the locating surfaces A, B of FIG. 9. In other embodiments, a beam of light may be projected parallel to the surface of the locating elements of interest or along a predetermined reference plane(s). Alternatively, a vision system could be employed to identify the position of the object to be measured relative to the reference planes. As would be understood by one skilled in the art, other usable sensors may now exist or may be later developed, and such sensors are considered to be within the scope of the present invention. It should also be understood that various combinations of sensors could be used in a system of the present invention.

Auto-detection with respect to the various and previously described measurement methodologies of the present invention are discussed in more detail below. Although not specifically shown, any of the aforementioned sensors and techniques may be used to provide the desired auto-detection function with respect to each of said measurement methodologies.

Auto-detection with respect to a one-touch measurement methodology of the present invention is illustrated in FIG. 9. As shown, an object to be measured may be oriented such that two side surfaces thereof are in contact with locating elements (surfaces) A, B lying in two reference planes X, Y. In such a case, a sensor(s) associated with both reference planes X, Y are activated and the system will know the relative orientation of the object with respect to both reference planes. When sensors associated with both reference planes are activated, the system also knows that the object can be measured using the one-touch measurement methodology.

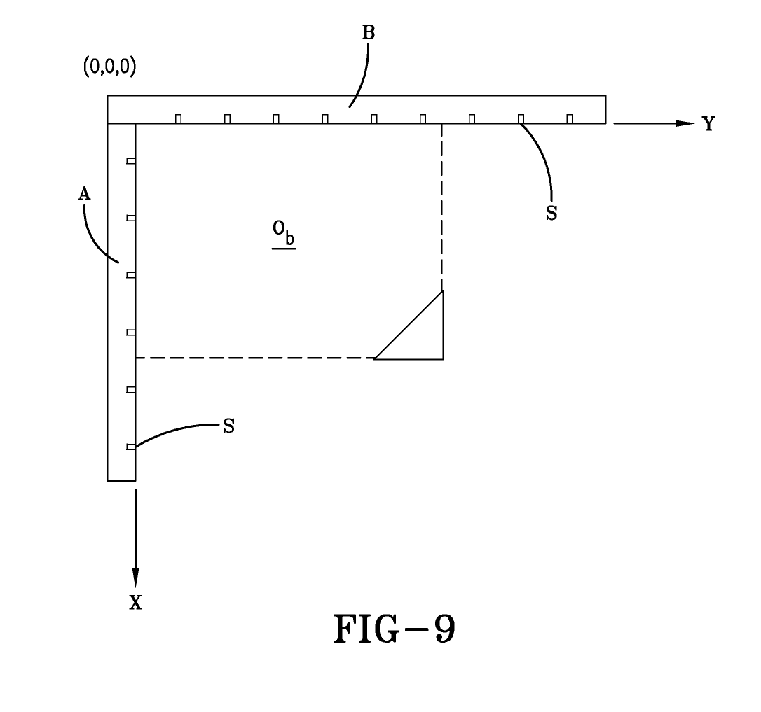

Auto-detection with respect to a two-touch measurement methodology of the present invention is illustrated in FIG. 10. As shown, an object to be measured may be oriented such that only one side surface thereof is in contact with a locating element (surface) A or B lying in one of two reference planes X or Y. In such a case, a sensor(s) S associated with only one reference plane X or Y is activated and the system will know the relative orientation of the object with respect to only one reference plane. When a sensor(s) associated with only one reference plane is activated, the system also knows that the object can be measured using the two-touch measurement methodology. In the case wherein the two-touch measurement methodology is sufficiently efficient, locating elements associated with one of the reference planes may be eliminated if desired.

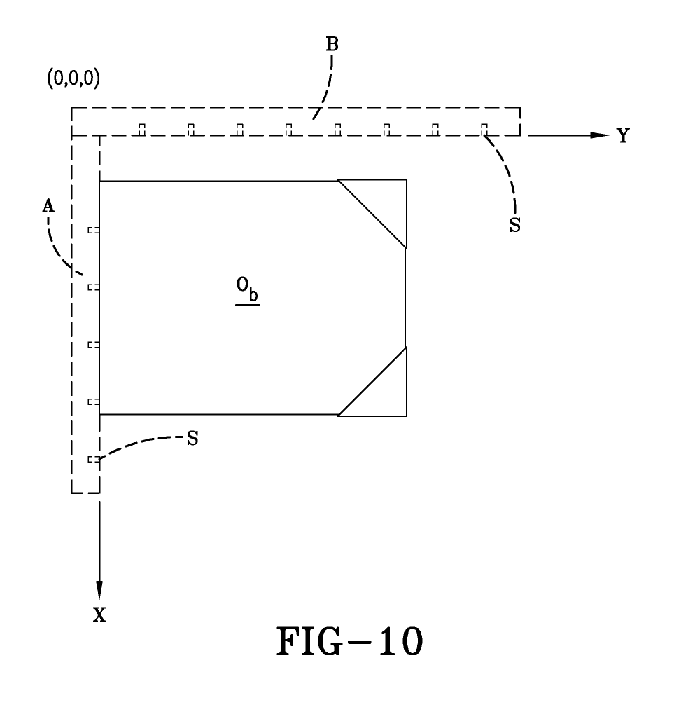

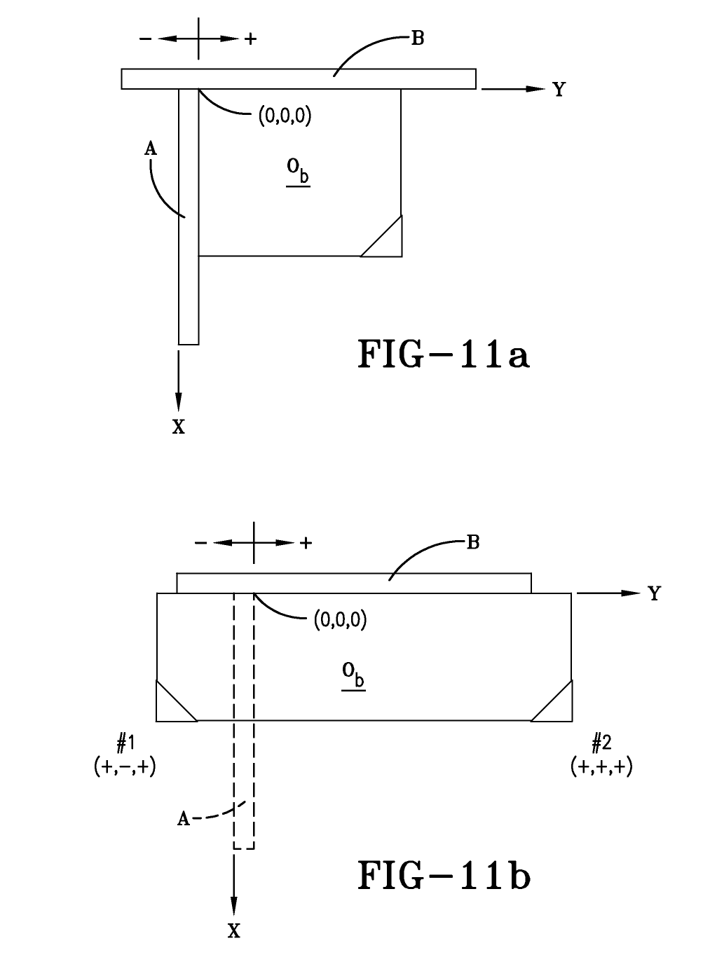

A variation of the auto-detection technique described above is shown in FIGS. 11a-11b. In this variation, a system of the present invention may be configured to automatically and appropriately select the one-touch or two-touch measurement methodology by detecting a negative dimension relative to either of the illustrated reference planes X, Y. During calibration of the system, the origin of the measurement field (0,0,0) is identified. Objects to be measured that are located within the measurement field defined by the extent of the locating surfaces A, B associated with the reference planes will always have positive coordinates. Thus, if a measurement is made and the calculated coordinates associated therewith all have positive values, the object is understood to be aligned with the locating surfaces A, B associated with both reference planes X, Y. Such coordinates also indicate use of the one-touch measurement methodology.

Alternatively, when a measurement is made and the calculated coordinates associated therewith include a negative X or Y value, it is understood that an object to be measured is aligned with one of the locating surfaces A, B and reference planes X, Y. Such a coordinate represents one of the two points used to calculate the dimensions of an object according to the two-touch measurement methodology. As such, a system of the present invention may be programmed to wait for a second point having all positive values before calculating the object dimensions.

For example, as shown in FIG. 11b, the first measurement point is labeled as #1. In this example, the X,Y,Z coordinates for this position are calculated as (8,−4,5). A second measurement is taken at the point labeled #2. The coordinates associated with this point are calculated to be (8,16,5). It is subsequently determined that the length, width and height of the object is 20, 8 and 5, respectively.

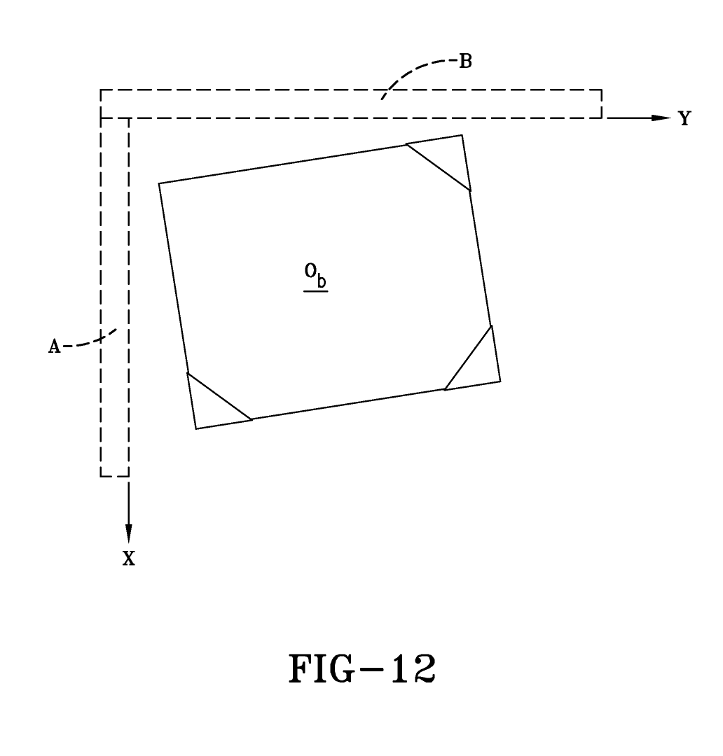

Auto-detection with respect to a three-touch measurement methodology of the present invention is illustrated in FIG. 12. As shown, an object to be measured may be oriented such that none of its side surfaces are in contact with a locating element (surface) A or B lying in either of the two known reference planes X or Y. As such, none of the sensors associated with either reference plane will be activated by the object. In this situation, the system does not know the orientation of the object to measured relative to either of the reference planes and, therefore, defaults to the three-touch measurement methodology. In the case wherein the three-touch measurement methodology is sufficiently efficient, the locating elements associated with both reference planes may be eliminated if desired.

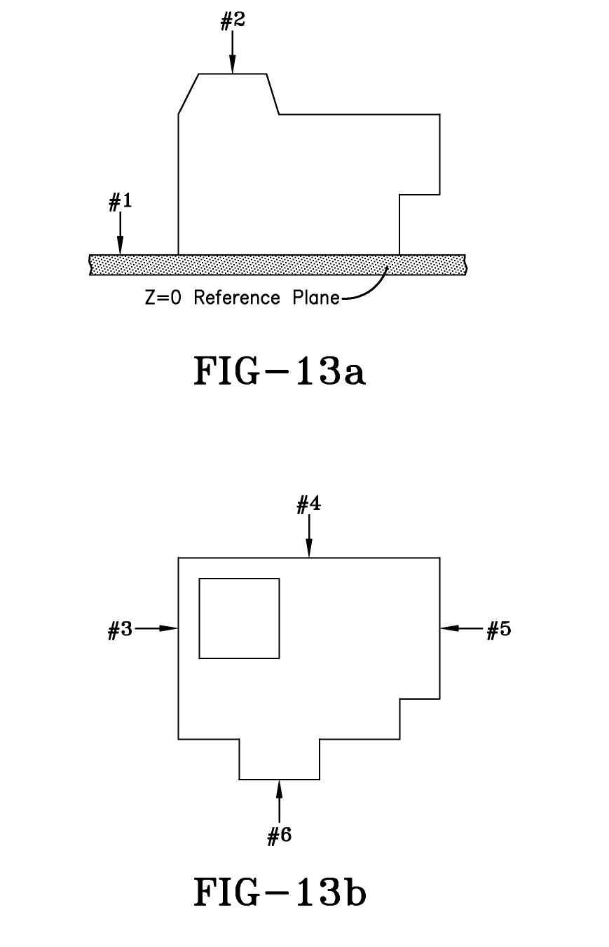

Auto-detection with respect to a five-touch measurement methodology of the present invention is illustrated in FIGS. 13a-13b. As previously discussed, the five-touch measurement methodology may be useful in determining the dimensions of the cuboidal envelope occupied by a non-hexahedral (irregularly-shaped) object. In one exemplary five-touch auto-detection mode, an additional initial first touch is added to signal to the system that a five-touch method is to be employed. The only requirement is that the first point (#1) of measurement occur anywhere on the axis defined by the support surface (z=0) upon which the object is resting. Since there is no other measurement methodology that requires a measurement be made on the axis defined by the support surface, the system can be programmed to default to a five-touch mode of operation. In this case, the second measurement point (#2) will provide the maximum height of the object, the third (#3) and fifth measurements (#5) will be used to calculate the maximum length of the object, and the fourth and sixth measurements (#4, #6) will be used to calculate the maximum width of the object.

It should be noted that there technically exists a four-touch measurement methodology. However, when working with cuboidal objects, the three-touch previously describe measurement methodology renders redundant the use of a fourth touch. That is, the object dimensions can be determined from just three points and, therefore, there is no need to employ a fourth touch (point). It is to be nonetheless understood that a four-touch measurement methodology is considered to be within the scope of the present invention. Further, if an object is not rectangular, the four-touch measurement methodology could useful in determining its shape.

It is realized that it may be occasionally desirable to measure packages having one or more dimensions in excess of those of an object support surface associated with a given system of the present invention. For example, such an object may have a length that extends considerably beyond the object support surface, possibly rendering it difficult for the object to be accurately aligned with existing locating elements and/or potentially resulting in problems with ultrasonic pulse reception by associated ultrasonic receivers.

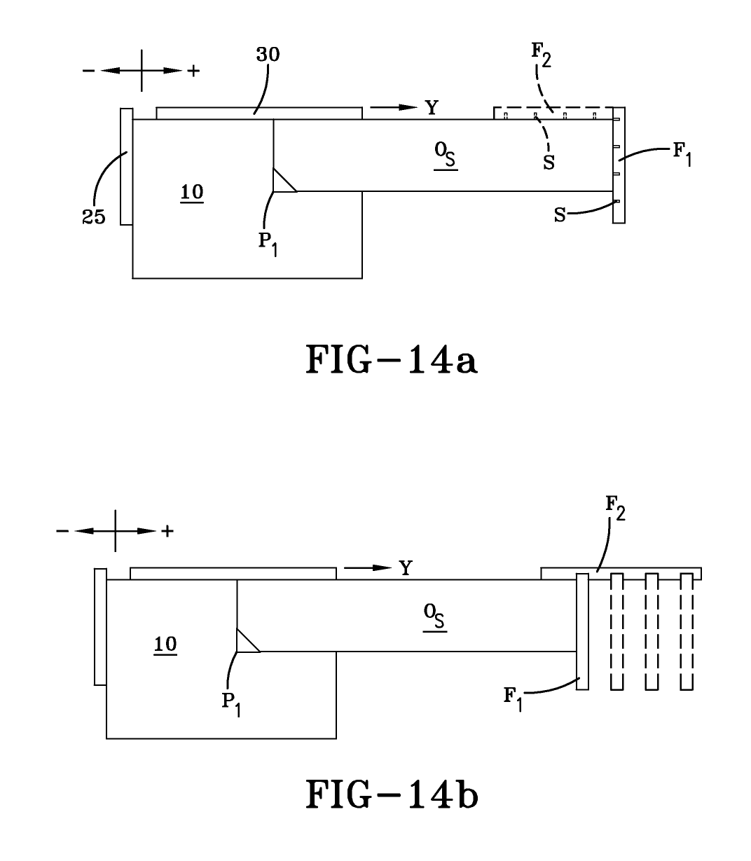

In light of the foregoing potential issues with oversize objects to be measured, various solutions for dealing with such may be provided according to the present invention. For example, as shown in FIGS. 14a and 14b, a system of the present invention may be specifically adapted to allow for measurement of oversize objects.

As shown in FIG. 14a, one or more oversize object locating elements (fixtures) F₁, F₂ may be added to a system of the present invention. The system 5 of FIG. 1 is shown in FIG. 14a as an example. These fixtures F₁, F₂ are designed to cooperate with the standard locating elements (e.g., locating surfaces 25, 30) which may be already present on a system of the present invention. In practice, a user of the system places an oversize object Oₛ partially on the object support surface 10, with one side surface thereof in contact with an existing locating surface 30. The end of the oversize object Oₛ that extends beyond the standard object support surface 10 is then placed into contact with oversize object position locating fixture F₁. A second side of the oversize object Oₛ may be placed in contact with a secondary oversize object locating fixture F₂ if such is present.

As with the previously described exemplary auto-detection system embodiments of the present invention, sensors S may be associated with the oversize object locating fixture(s) F₁, F₂ so as to automatically detect when an oversize object Oₛ is present. Alternatively, manual indication of the presence of an oversize object may be permitted or required, such as through a software user interface, etc. Automatic or manual oversize object indication can also be employed with respect to the alternative oversize object measurement embodiments described below.

In any event, with an oversize object Oₛ located as shown in FIG. 14a, an electronic pointer is subsequently positioned to the only upper corner P₁ of the object that has no associated face located by a locating element. Because the necessary coordinates associated with the object support surface 10 and locating fixture F₁ are known, measurement of the oversize object Oₛ may be accomplished using the one-touch methodology described above.

An alternative oversize object Oₛ one-touch measurement technique is depicted in FIG. 14b. As shown, both oversize object locating fixtures F₁, F₂ are present in this embodiment. Further, the position locating fixture F₁ is moveable between various positions along the length of the secondary locating fixture F₂. The function and operation of this embodiment is substantially the same as that of the embodiment shown in FIG. 14a, except that the ability to reposition the position locating fixture F₁ permits the measurement of oversize objects having greater length differences. In this regard, it should be understood that the secondary locating fixture running along what is labeled as the Y axis could extend to or near the end of the locating surface 30. As such, the position locating fixture F₁ could then be located anywhere from very near the object support surface 10 to the lengthwise extent of the secondary locating fixture F₂ in order to accommodate oversize objects of varying length.

In one variation of this embodiment, the position locating fixture F₁ may be moved between preset positions along the length of the secondary locating fixture F₂. In another variation, the position locating fixture F₁ may be infinitely locatable along the length of the secondary locating fixture F₂. In this latter embodiment, a means of determining and reporting the location of the position locating fixture F₁ along the secondary locating fixture F₂ is provided. Such means may include an encoder, optical or laser-based measurement systems, or any other such devices known to one skilled in the art.

With an oversize object Oₛ located as shown in FIG. 14b, use of an electronic pointer and measurement of the oversize object Oₛ may be accomplished as described with respect to the exemplary embodiment of FIG. 14a.

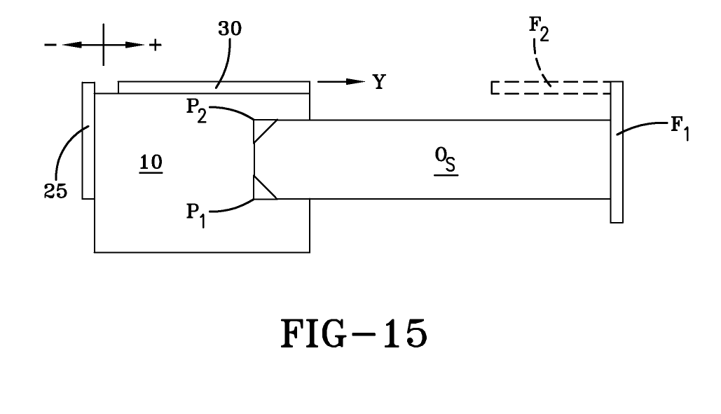

Measurement of an oversize object OS using a two-touch measurement methodology is illustrated in FIG. 15. The oversize object Oₛ is once again partially located on the object support surface 10 to extend therefrom. Locating elements, such as locating surfaces 25, 30, may or may not be associated with the object support surface 10. Either of the oversize object locating fixture arrangements shown in FIG. 14a or 14b may be employed to properly position the oversize object Oₛ for measurement. The measurement procedure then proceeds and is accomplished as described above in regard to the two-touch measurement methodology. As represented in FIG. 15, the points P₁, P₂ to be touched with the electronic pointer coincide with the upper corners of the face of the object that is opposite to the face in contact with the position locating fixture F₁.

One skilled in the art would realize that there are likely many possible equivalents to the particular exemplary oversize object locating fixtures illustrated in FIGS. 14-15 and described above. As such, nothing herein is to be considered as limiting the scope of the present invention to the use of such fixtures. Rather, virtually any fixture that can accurately position the side of an oversize object to be measured may be used in the present invention.

As briefly discussed above, a system of the present invention may be portable in nature, so as to be transportable to an object(s) of interest. The only real requirement is that the object or the support surface upon which the object(s) rests does not change position after the system is set up and calibrated with respect thereto. As such, suitable support surfaces may include, for example, the floor of a warehouse or other building, or the ground of an outdoor location.

In such a case, a system of the present invention may be taken to the location of the object(s) and temporarily set up in place. Ultrasonic receivers may be positioned on portable stands or towers, for example, or may be attached to other already existing structures associated with the location of the object(s). A portable system may be particularly useful in situations where an object of interest is too large or too heavy to be easily moved and/or set upon an existing object support surface. For example, a portable system may be well-suited to measuring large and heavy objects residing on pallets

Depending on the configuration, a user of the system might define alignment axes that can be used with certain of the previously described measurement methodologies to measure the object(s) of interest. For example, axis markings may be created, or locating elements may be positioned adjacent to the object(s) prior to calibration. As such, it can be understood that, depending on the object(s), each of the one-touch, two-touch, three-touch and five-touch measurement methodologies may be used with a portable system of the present invention.

In a variation of a portable system, only a portion of the system may be portable. For example, an ultrasonic receiver assembly may be pre-installed in a warehouse, factory, etc., setting where large and/or heavy objects may need to be periodically measured. The receiver assembly may be installed overhead or in another location where ultrasonic pulses sent thereto are less likely to be blocked. Such a pre-installation of an ultrasonic receiver assembly may expedite the remainder of the portable system setup process while still allowing for measurement according to the present invention at various object locations.

While certain embodiments of the present invention are described in detail above, the scope of the invention is not to be considered limited by such disclosure, and modifications are possible without departing from the spirit of the invention as evidenced by the following claims:

What is claimed is:

1. An ultrasonic system for dimensioning a cuboid object, comprising:
an object support surface;
at least three ultrasonic receivers positioned about said cuboid object when said cuboid object resides on said object support surface;
at least one moveable ultrasonic transmitter for transmitting ultrasonic pulses to said at least three ultrasonic receivers while touching said cuboid object; and
a microprocessor in communication with said at least three receivers and said at least one transmitter, said microprocessor programmed with at least one multilateration algorithm.

2. The system of claim 1, further comprising one or more locating elements associated with said object support surface, said one or more locating elements for locating at least one side of said cuboid object that is substantially perpendicular to said object support surface.

3. The system of claim 2, wherein said one or more locating elements are attached to said object support surface.

4. The system of claim 2, wherein said one or more locating elements are one or more markings on a visible face of said object support surface.

5. The system of claim 2, further comprising one or more sensors associated with said one or more locating elements, said sensors for automatically detecting the presence of said cuboid object.

6. The system of claim 1, wherein said object support surface is a weighing scale.

7. The system of claim 1, further comprising an ultrasonic pulse calibrator for providing measurements used to compensate said ultrasonic pulses emitted by said at least one ultrasonic transmitter for the effects of one or more atmospheric conditions on the speed of sound.

8. The system of claim 1, further comprising atmospheric sensors for providing measurements used to compensate said ultrasonic pulses emitted by said at least one ultrasonic transmitter for the effects of one or more atmospheric conditions on the speed of sound.

9. The system of claim 1, wherein said microprocessor is a microcontroller.

10. The system of claim 1, wherein said ultrasonic transmitter is adapted to transmit an ultrasonic pulse only when activated by a user.

11. The system of claim 1, wherein said ultrasonic transmitter is adapted to transmit an ultrasonic pulse automatically when touched to said cuboid object.

12. A one-touch ultrasonic method of dimensioning a cuboid object, comprising:
providing an ultrasonic dimensioning system, said system further comprising:
a substantially planar object support surface,
at least three ultrasonic receivers positioned to be above said cuboid object when said cuboid object resides on said object support surface,
at least one ultrasonic transmitter for transmitting ultrasonic pulses to said at least three ultrasonic receivers while touching said cuboid object,
at least two locating elements for locating at least two orthogonal sides of said cuboid object that extend substantially perpendicularly to said object support surface, and
a microprocessor in communication with said at least three receivers and said at least one transmitter, said microprocessor programmed with at least a one-touch multilateration algorithm,
placing said cuboid object on said object support surface such that said two orthogonal sides are located by said at least two locating elements;
touching said ultrasonic transmitter to the top corner of said cuboid object that is diagonally opposite said two orthogonal sides;
causing said ultrasonic transmitter to emit an ultrasonic pulse while touching said top corner;
receiving said ultrasonic pulse at said ultrasonic receivers; and
using said one-touch multilateration algorithm to calculate the dimensions of said cuboid object.

13. The method of claim 12, further comprising using an ultrasonic pulse calibrator to compensate for the effects of one or more atmospheric conditions on the speed of travel of said ultrasonic pulses emitted by said ultrasonic transmitter.

14. The method of claim 12, further comprising using readings from atmospheric sensors to compensate for the effects of one or more atmospheric conditions on the speed of travel of said ultrasonic pulses emitted by said ultrasonic transmitter.

15. The method of claim 12, further comprising providing sensors to automatically detect the presence of said cuboid object against said at least two locating elements and to automatically select said one-touch multilateration algorithm to calculate the dimensions of said cuboid object.

16. A two-touch ultrasonic method of dimensioning a cuboid object, comprising:
providing an ultrasonic dimensioning system, said system further comprising:
a substantially planar object support surface,
at least three ultrasonic receivers positioned to be above said cuboid object when said cuboid object resides on said object support surface,
at least one ultrasonic transmitter for transmitting ultrasonic pulses to said at least three ultrasonic receivers while touching said cuboid object,
at least one locating element for positioning at least one side of said cuboid object that extends substantially perpendicularly to said object support surface; and
a microprocessor in communication with said at least three receivers and programmed with at least a two-touch multilateration algorithm,
placing said cuboid object on said object support surface such that one side of said cuboid object is located against said at least one locating element;
separately touching said ultrasonic transmitter to the two top corners of said cuboid object that are triagonally opposed to the two bottom corners of said side of said object that is positioned against said at least one locating element;
causing said ultrasonic transmitter to emit an ultrasonic pulse while touching each of said top corners;
receiving said ultrasonic pulses at said ultrasonic receivers; and
using said two-touch multilateration algorithm to calculate the dimensions of said cuboid object.

17. The method of claim 16, further comprising using an ultrasonic pulse calibrator to compensate for the effects of one or more atmospheric conditions on the speed of travel of said ultrasonic pulses emitted by said ultrasonic transmitter.

18. The method of claim 16, further comprising using readings from atmospheric sensors to compensate for the effects of one or more atmospheric conditions on the speed of travel of said ultrasonic pulses emitted by said ultrasonic transmitter.

19. The method of claim 16, further comprising providing sensors to automatically detect the presence of said cuboid object against said at least one locating element, and to automatically select said two-touch multilateration algorithm to calculate the dimensions of said cuboid object.

20. A three-touch ultrasonic method of dimensioning a cuboid object, comprising:
providing an ultrasonic dimensioning system, said system further comprising:
a substantially planar object support surface,
at least three ultrasonic receivers positioned to be above said cuboid object when said cuboid object resides on said object support surface,
at least one ultrasonic transmitter for transmitting ultrasonic pulses to said at least three ultrasonic receivers while touching said cuboid object, and
a microprocessor in communication with said at least three receivers and said at least one transmitter, said microprocessor programmed with at least a three-touch multilateration algorithm,
placing a bottom surface of said cuboid object on said object support surface;
separately touching said ultrasonic transmitter to any three top corners of said cuboid object;
causing said ultrasonic transmitter to emit an ultrasonic pulse while touching each of said any three top corners;
receiving said ultrasonic pulses at said ultrasonic receivers; and
using said three-touch multilateration algorithm to calculate the dimensions of said cuboid object.

21. The method of claim 20, further comprising using an ultrasonic pulse calibrator to compensate for the effects of one or more atmospheric conditions on the speed of travel of said ultrasonic pulses emitted by said ultrasonic transmitter.

22. The method of claim 20, further comprising using readings from atmospheric sensors to compensate for the effects of one or more atmospheric conditions on the speed of travel of said ultrasonic pulses emitted by said ultrasonic transmitter.

23. A five-touch ultrasonic method of dimensioning a cuboid of a size sufficient to enclose an object of interest, comprising:
providing an ultrasonic dimensioning system, said system further comprising:
a substantially planar object support surface,
at least three ultrasonic receivers positioned to be above said object of interest when said object of interest resides on said object support surface,
at least one ultrasonic transmitter for transmitting ultrasonic pulses to said at least three ultrasonic receivers while touching said cuboid object, and
a microprocessor in communication with said at least three receivers and said at least one transmitter, said microprocessor programmed with at least a five-touch multilateration algorithm,
defining a major axis of said object of interest;
separately touching said ultrasonic transmitter, in no particular order, to two points on opposite sides of said object of interest and lying as far apart as possible on lines substantially parallel to said major axis, and to two points on opposite sides of said object of interest and lying as far apart as possible on lines substantially perpendicular to said major axis;
subsequent thereto, touching said ultrasonic transmitter to a fifth point, said fifth point being a point on said object of interest that lies the farthest away from said object support surface;
causing said ultrasonic transmitter to emit an ultrasonic pulse while touching each of said five points;
receiving said ultrasonic pulses at said ultrasonic receivers; and
using said five-touch multilateration algorithm to calculate the dimensions of a cuboid of sufficient size to enclose said object of interest.

24. The method of claim 23, wherein said substantially planar object support surface is a floor.

25. The method of claim 23, wherein said ultrasonic dimensioning system is portable and may be transported to the location of said object of interest.
